(19) United States
(12) Patent Application Publication
(10) Pub. No.: US 2022/0100252 A1
(43) Pub. Date: Mar. 31, 2022

(54) SETTING DEVICE STATES BASED ON MODES

(71) Applicant: Hewlett-Packard Development Company, L.P., Spring, TX (US)

(72) Inventors: Cem Deniz Polat, Spring, TX (US); Alexander Clark, Spring, TX (US); Peter Zhang, Spring, TX (US)

(73) Assignee: Hewlett-Packard Development Company, L.P., Spring, TX (US)

(21) Appl. No.: 17/296,406

(22) PCT Filed: Jun. 14, 2019
(86) PCT No.: PCT/US2019/037377

§ 371 Date: May 24, 2021

(51) Int. Cl. G06F 1/3231; G06F 1/3209; G06N 20/00; G06F 1/3293

(52) U.S. Cl. CPC G06F 1/3231; G06F 1/3293; G06N 20/00; G06F 1/3209

(57) ABSTRACT

In one example, an electronic device state may be set based on user activity modes. The electronic device may include a battery; a power adapter; a sensor device; a processor; and memory storing machine-readable instructions to cause the processor to: determine, using sensor device data, which one of a walk mode and a backpack mode the electronic device is in, where the electronic device is in motion during the walk mode, and the electronic device is in motion and is disposed in a bag during the backpack mode; and where the machine-readable instructions set the electronic device to a device ready if the electronic device is in the walk mode, set the electronic device to a low power state to reduce battery power usage if the electronic device is in the backpack mode.

### BACKGROUND

A portable electronic device (PED) is a lightweight device with data processing capabilities. An example of a PED is a laptop computer. Another example is a tablet. Users of PEDs may include college students, professionals and the like. A laptop computer can be electrically or battery powered. The battery can sustain the laptop computer fora limited duration after which the battery is recharged. A laptop computer can also perform data processing. After the laptop is powered on, a delay can exist before the laptop computer becomes ready for use by the user.

### BRIEF DESCRIPTION OF THE DRAWINGS

FIG. 1 illustrates an electronic device in accordance with an example of the present disclosure.

FIG. 2 illustrates a first user and a second user with electronic devices operating in different user activity modes.

FIG. 3 illustrates a table showing an example of usage trends for electronic device 100 of FIG. 1.

FIG. 4 illustrates a computer-readable storage medium according to an example of the present disclosure.

FIG. 5 illustrates a computer storage medium according to an example of the present disclosure.

### DETAILED DESCRIPTION

A challenge for many electronic devices is that battery power can sustain such electronic devices for a limited duration. And, many electronic devices also have minimal power saving capabilities. For example, in many electronic devices, system power-saving is executed when the electronic device is already at a low power/battery level or when a user manually changes the electronic device into a power-saving mode. Such challenges not only impact user experience but can impact system performance as well.

The present disclosure facilitates detection of a user activity mode such as the walk mode which automatically executes power saving techniques without the need for a user to initiate power saving. Upon detection of a user activity mode such as a backpack mode, the present disclosure can set battery power to a low power state or other comparable power states including shutting down the system to conserve battery power. In this manner, batteries can sustain electronic devices for much longer durations.

Another challenge for many electronic devices is the slow restart of programs due to low system readiness caused by CPU performance re-allocation, cache memory loading, etc. When a user activity mode such as a walk mode is detected, the present disclosure can adjust system readiness levels based on detected user activity mode for which users are expected to use their electronic devices in a short period of time.

In one example, an electronic device of the present disclosure includes a power adapter, a battery and a sensor device. The sensor device is to provide sensor device data to determine a user activity mode. The electronic device also includes a processor and memory-storing machine-readable instructions to cause the processor to use sensor data to determine which one of the user activity modes the device is in.

In this example, the determined user activity mode is one of a walk mode or a backpack mode. In the walk mode, the electronic device is determined to be in motion with the user walking with the electronic device in hand. In the backpack mode, the electronic device is determined to be in motion with the electronic device disposed in a backpack while the user is walking with the backpack. Although not shown, a determination between other types of user activity modes can be made.

Here, the electronic device is then set to a device ready state if the electronic device is in walk mode. In this manner, the user can immediately begin to utilize the electronic device without having to wait an inordinate amount of time for the electronic device to reach a ready state. If the electronic device is in a backpack mode, the electronic device is set to a low power state to reduce the battery power usage. In this manner, the battery can sustain the electronic device for longer periods of time.

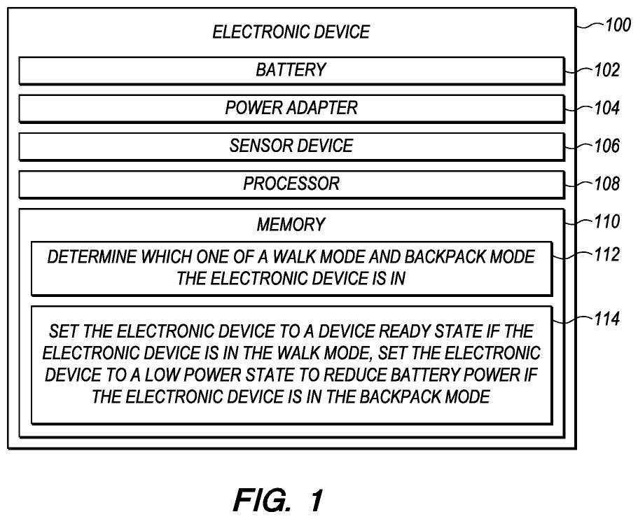

FIG. 1 illustrates an electronic device 100 in accordance with an example of the present disclosure.

In FIG. 1, electronic device 100 may be a laptop computer that has a battery 102 and power adapter 104. Power adapter 104 can have a prong for insertion into a voltage source. A voltage source can be a 110v or 220v power supply although other standard voltage sources may be employed.

Once connected to the appropriate voltage source, power adapter 104 converts alternating current from the voltage source to direct current for use by electronic device 100. The direct current provided may vary based on the particular electronic device.

Battery 102 is a container and can include one or more cells to create current. The container can also include an anode, a cathode and electrolyte to supply power to electronic device 100. Battery 102 can be a rechargeable battery. For example, battery 102 can be lithium ion, lithium polymer, nickel cadmium or the like.

In FIG. 1, electronic device 100 further includes sensor device 106, processor 108 and memory 110. Here, sensor device 106 can be an accelerometer or gyroscope to acquire acceleration data. In particular, in one mode, namely the walk mode, acceleration data of electronic device 100 in motion is obtained. More specifically, as the user walks with electronic device in hand, the acceleration data is acquired.

In another mode, namely the backpack mode, acceleration data of electronic device 100 in motion is also obtained. However, unlike the walk mode in which acceleration data is obtained while electronic device 100 is in the user's hand, here, the acceleration data is acquired while the user is walking with a backpack with electronic device 100 disposed in the backpack.

Although not illustrated, electronic device 100 may include additional sensors. For example, electronic device 100 may also include a pressure sensor. The pressure sensor can detect a pressure difference to determine when electronic device 100 has been put in a backpack and to determine air movement inside the backpack relative to air movement outside of the backpack. Slight pressure changes due to air movement around electronic device 100 can be detected.

Processor 108 can be a central processing unit (CPU), a semiconductor-based microprocessor or other hardware device suitable for retrieval and execution of instructions stored in memory 110. Alternatively or in addition to retrieving executed instructions, processor 108 may include an electronic circuit that includes electronic components for performing the functionality of instructions 112, 114 ora combination thereof.

Memory 110 can include volatile and non-volatile memory. For example, memory 110 can be removable memory or non-removable memory. For example, memory 110 can be random access memory (RAM) (e.g., dynamic random access memory) (DRAM) and/or phase change random access memory (PCRAM), read-only memory (ROM), electronically erasable programmable read-only memory (EEPROM) and/or compact disc read-only memory (CD-ROM) or flash memory.

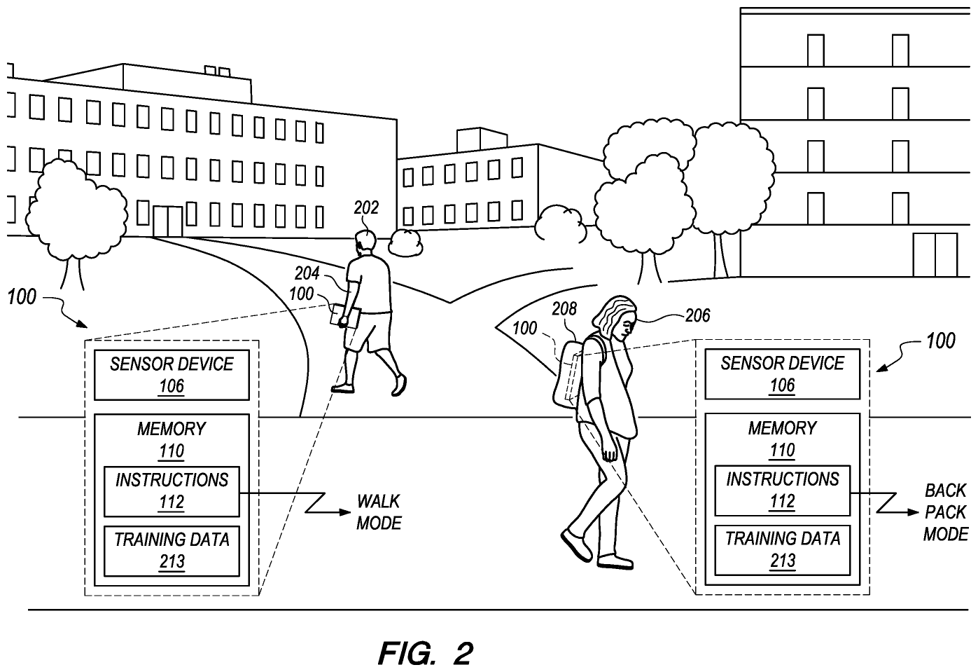

In FIG. 1, instructions 112, when executed by processor 108, may cause processor 108 to determine which one of a walk mode or a backpack mode electronic device 100 is in. The walk mode and the backpack mode are further described below with reference to FIG. 2.

Instructions 114, when executed by processor 108, can cause processor 108 to set electronic device 100 to a device ready state if the electronic device is in the walk mode or set electronic device 100 to a low power state to reduce battery 102 power usage if electronic device 100 is in the backpack mode.

FIG. 2 illustrates a first user 202 and a second user 206 with electronic devices 100 operating in different user activity modes.

In the example of FIG. 2, electronic device 100 of first user 202 is in a walk mode, and electronic device 100 of user 206 is in the backpack mode. Although not illustrated, other comparable user activity modes may be used by electronic device 100.

As shown in FIG. 2, both first user 202 and second user 206 are college students walking with electronic devices 100 on a college campus. Such college students may employ electronic device 100 during class attendance and other academic tasks. To facilitate such tasks, electronic device 100 can be in one of a walk mode and a backpack mode when motion is detected.

Backpack Mode: In FIG. 2, second user 206 is shown walking away from the college campus with electronic device 100 in backpack 208. It can therefore be inferred that second user 206 is going home and that electronic device 100 will not be used for an extended period of time. This inference may be validated by training data 213 that is based on artificial intelligence as discussed below.

Thus, when electronic device 100 is initially placed into backpack 208, sensor device 106 detects motion and begins to acquire relevant sensor data such as accelerometer data. Contemporaneously or shortly thereafter, electronic device 100 executes instructions 112 (FIG. 1) to determine whether electronic device 100 is in a walk mode or a backpack mode. Specifically, electronic device 100 uses the accelerometer data from sensor device 106 to determine whether the electronic device is in a walk mode or backpack mode.

In one example, the determination is based solely on sensor data from sensor device 106. However, one challenge is to ensure a high level of certainty that electronic device 100 is indeed in a specific mode. For example, if the user merely places electronic device 100 in motion without the user walking, sensor data 106 would incorrectly indicate motion.

Therefore, in another example of the present disclosure, determination of the activity mode of electronic device 100 is based not only on sensor data but on additional data such as training data 213 to further validate the determined activity mode. In particular, sensor device data is correlated with AI (aritifical intelligence)-based training data 213 of a subject walking with an electronic device in a backpack to validate that second user 206 is indeed walking with electronic device 100 in backpack 208. In this manner, a high degree of validation and certainty is obtained that second user 208 is in the backpack mode.

Here training data 213 can be data that is collected for a subject walking with an electronic object in a backpack. Specifically, training data 213 may be reference sensor device data of the subject walking with the electronic device disposed in the backpack. For example, training data 213 may include sensor device data from a triaxial accelerometer that generates data along three dimensions of movement (x-axis, y-axis and z-axis). The x-axis captures the horizontal movement of the user, the y-axis captures the forward and backward movement and the z-axis captures the upward and downward movement.

As second user 206 continues to utilize electronic device 100 for desired tasks, additional accelerometer data is continuously captured. This set of accelerometer data may then be applied to the AI-based training model to increase accuracy of identification of motion by second user 206. The AI-based training model is continuously refined with acceleration data for second user 206.

In addition to accelerometer data, pressure sensor data may also be collected to provide supplemental information on correctly determining if electronic device 100 has been placed into backpack 208. The pressure sensor detects the change of air movement when electronic device 100 is outside or inside backpack 208.

Once the acceleration data is correctly correlated with artificial intelligence-based training acceleration data, backpack mode is activated, and the system sets the battery power to a low power state or other comparable power state including shutting down the device to conserve battery power.

One challenge is that battery power can only sustain many electronic devices for a limited duration. Many such electronic devices also have minimal power saving capabilities. System power-saving is executed when the electronic device is already at a low power/battery level or when a user manually changes the electronic device into a power-saving mode. A power-saving mode may also be entered when an electronic device has not registered any input for a long period of time after which the system automatically goes into a power-saving mode. Such challenges not only impact user experience but can impact system performance as well.

The present disclosure facilitates detection of a user activity mode such as the walk mode which automatically executes power saving techniques without the need for a user to initiate power saving. Upon detection of a walk mode, the present disclosure can set battery power to a low power state or other comparable power states including shutting down the system to conserve battery power. In this manner, batteries can sustain electronic devices for much longer durations.

Walk Mode: Referring to FIG. 2, first user 202 is shown walking toward a campus building with electronic device 100 in hand. It can therefore be inferred that first user 202 is going to class and will use electronic device 100 within a short duration. This inference may be validated by training data 213 that is artificial intelligence.

When first user 202 begins to walk with electronic device 100 in hand, sensor device 106 detects motion and begins to obtain appropriate data such as accelerometer data. Concurrently or shortly thereafter, electronic device 100 executes instructions 112 (FIG. 1) to determine whether electronic device 100 is in a walk mode or a backpack mode. Specifically, electronic device 100 uses the accelerometer data from sensor device 106 to determine whether the electronic device is in a walk mode or backpack mode.

In one example, the determination of mode is based solely on sensor data from sensor device 106. However, one challenge is to ensure a high level of certainty that electronic device 100 is indeed in a specific mode. For example, if the user merely stands up with electronic device 100 with the electronic device in hand (without walking), motion would be incorrectly detected.

In another example of the present disclosure, determination of the activity mode of electronic device 100 is based not only on sensor device data but on additional data such as training data 213. In particular, sensor device data is correlated with Al-based training data 213 of a subject walking with an electronic device in hand to validate that second user 206 is indeed walking with electronic device 100 in hand. In this manner, a high degree of validation and certainty is obtained that first user 202 is in the walk mode.

In one example, training data 213 can be data that is collected for a subject walking with an electronic object in hand. Such training data can provide acceleration data for the electronic object in hand based on human physiology and natural human movement characteristics. Beyond merely facilitating detection of motion, training data 213 enables motion detection based on acceleration traits and trends across human joints and bodies.

Training data 213 may be reference sensor device data of the subject walking with the electronic device disposed in hand. For example, training data 213 may include sensor device data from a triaxial accelerometer that generates data along three dimensions of movement (x-axis, y-axis and z-axis). The x-axis captures the horizontal movement of the user; the y-axis captures the forward and backward movement, and the z-axis captures the upward and downward movement.

As second user 206 continues to utilize electronic device 100 to accomplish desired tasks, additional accelerometer data is continuously captured. This set of accelerometer data may then be applied to the Al-based training model to increase accuracy of identification of motion by first user 202. The Al-based training model is continuously refined with acceleration data for first user 202.

Once the acceleration data is correctly correlated with artificial intelligence-based trained walking acceleration data, walking mode is activated, and the system stays ready without decreasing CPU performance for the predicted time of next usage so that the system can remain on high system readiness during short periods of time.

Thus, a challenge for many electronic devices is the slow restart of programs due to low system readiness caused by CPU performance re-allocation, cache memory loading, etc. The present disclosure can adjust system readiness levels based on detected user activity mode—e.g., walk mode, for which users are expected to use their electronic devices in a short period of time, such periods of time being based on usage trends or historical usage data.

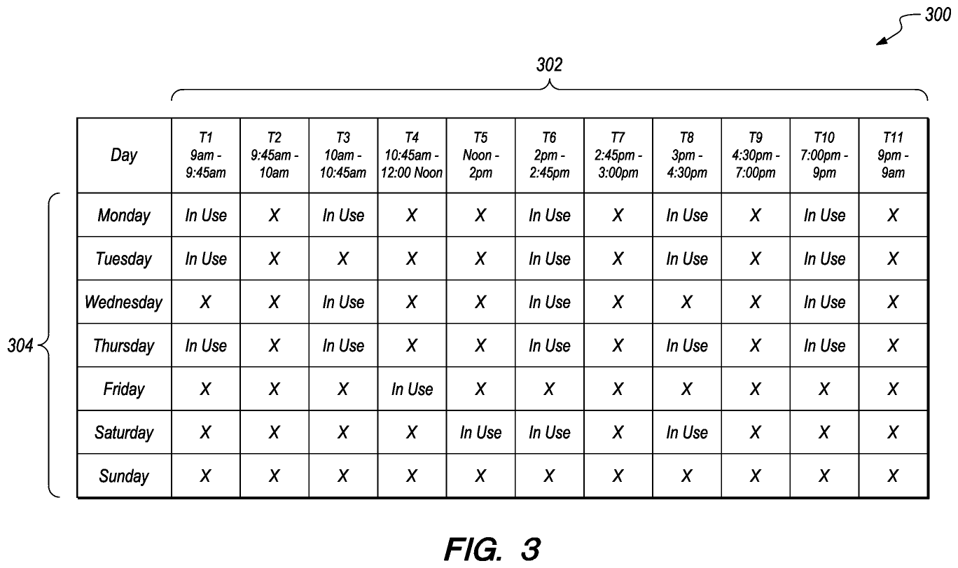

FIG. 3 illustrates a table 300 showing an example of usage trends for electronic device 100 (FIG. 1).

In FIG. 3, the columns 302 show the times when electronic device 100 is in use. Columns 302 also show when electronic device 100 is not in use. The rows 304 show corresponding days of usage or non-usage. In this example, table 300 may correspond to the class schedule of first user 202 (FIG. 2). However, other examples of usage trends for different users may be utilized.

Thus, in FIG. 3, on Monday at time T1 (9:00 am-9:45 am), electronic device 100 is in—use by first user 202 during a class session. Next, at time T2 (9:45 am-10:00 am), electronic device 100 is not in use as indicated by X. Here, electronic device 100 is in motion. Specifically, electronic device 100 is in the hand of first user 202 who is walking to another class. At time T3, (10:00 am-10:45 am) electronic device 100 is in use while user 202 is in another class.

At time T4 (10:45 am-12:00 noon), electronic device 100 is not in use during a free period for first user 202. At time T5 (12:00 noon-2:00 pm), it is lunchtime, and so electronic device 100 is not in use. At time T6 (2:00 pm-2:45 pm), electronic device 100 is in use during a class session.

At time T7 (2:45 pm-3:00 pm), electronic device 100 is not in use, but is in motion. Specifically, electronic device 100 is being held by first user 202 who is walking to another class. At time T8 (3:00 pm-4:30 pm), electronic device 100 is in use.

At time T9 (4:30 pm-7:00 pm), electronic device 100 is not in use; at time T10 (7:00 pm-9:00 pm), electronic device 100 is in use, and finally, at time T11 (9:00 pm-9:00 am) at substantially night time, electronic device 100 is not in use. The usage schedules for Tuesday, Wednesday, Thursday, Friday, Saturday and Sunday are also delineated in table 300.

Referring now to FIG. 3, in one example, table 300 may be applied to validate the user activity mode of electronic device 100. As an example, on Monday at T1, if sensor data were to indicate that electronic device 100 is in a backpack mode, that sensor data would be ignored as being erroneous because the usage trend data shows electronic device 100 is in use at T1. This situation can occur, for example, if first user 202 picked up electronic device 100 and walked over to a colleague during a class session.

As another example, table 300 may also validate a correct user activity mode. For example, on Monday at T2, electronic device 100 determines that the user activity mode is a walk mode. This determined mode may be validated by table 300 which shows that at T2, between 9:45 am and 10:00 am, electronic device 100 is not in use. Electronic device 100 is in the hand of first user 202 while walking to another class. Thus, electronic device 100 is in the correct user activity mode.

In another example of the present disclosure, table 300 is to determine the time duration of a device state following a user activity mode. For example, on Monday at T2, electronic device 100 may be determined as being in a walk mode. Following this determination, electronic device 100 may then be set to a device ready state. The duration of the ready state can be based on usage trends of table 300. Here, because the duration of nonuse is no more than 15 minutes (T2), the device readiness state of electronic device 100 can be set to high for 15 minutes.

In another example of the present disclosure, table 300 is to determine a time of next use of electronic device 100. For example, on Tuesday at T7, 2:45 pm, electronic device 100 can determine that the time of next use of electronic device 100 is T8, 15 minutes later. Such a determination can facilitate adjustment of a change of state or setting if the device is not used shortly after the time of next use. For example, electronic device 100 may be adjusted from the device ready state to a low power state if electronic device 100 remains unused after the previously determined time of next use.

As used here, in one example, electronic device 100 remains unused if the lid of the electronic device is not opened. In another example, electronic device 100 may be used if a user input (e.g. from a keyboard or touchscreen interface) is not detected.

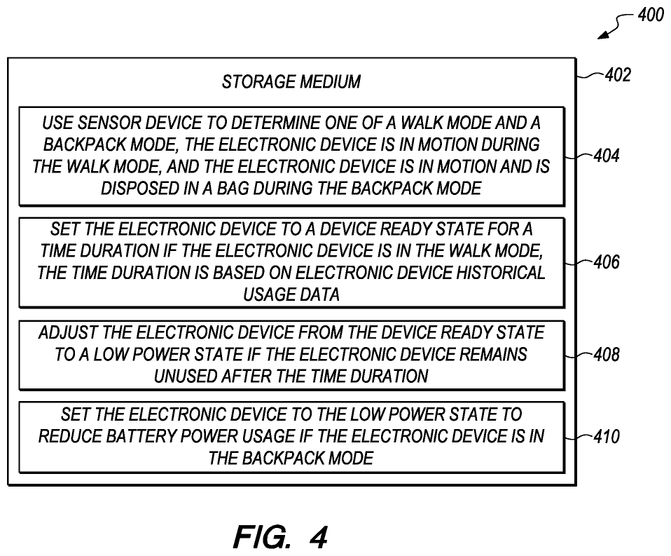

FIG. 4 illustrates a computer-readable storage medium 400 according to an example of the present disclosure.

Storage medium 400 can include non-transitory machine-readable storage medium 402. Non-transitory machine-readable storage medium 402 may be magnetic, optical, electronic or other storage devices that can execute machine-readable storage instructions. Non-transitory machine-readable storage instructions 402 may be delivered via EEPROM (electrically-erasable programmable read-only memory), RAM (random access memory) or other such devices.

Alternatively, non-transitory machine-readable storage medium 402 may be remote allowing the system to download instructions. Non-transitory machine-readable storage medium 402 may also be encoded with executable instructions to determine user activity modes and set device states.

Instructions 404 may include instructions to use sensor data to determine one or a walk mode and a backpack mode. Electronic device 100 is in motion during the walk mode. Here, electronic device 100 may be detected in motion as the user is walking with the electronic device in the user's hand.

During the backpack mode, electronic device 100 is in motion and is disposed in a bag. Here, the sensor device data may include acceleration data from an accelerometer or gyroscope or other comparable devices.

Instructions 406 may include instructions to set electronic device 100 to a device ready state for a time duration if the electronic device is in the walk mode. The time duration may be based on electronic device historical usage data.

An example of a device ready state or device readiness state is the completion of processor performance allocation so usage of the electronic device can begin. The device ready state may also be completion of secondary cache memory loading so usage of the electronic device can begin. The device ready state may also be completion of a boot-up process by electronic device 100.

Another example of the device ready state is when individual components are powered-on and cycled through boot-up sequences. As another example, during the device ready state, receivers may be enabled and connected to network connections. Although not discussed, there may be other examples of a device ready state. For example, the device ready state may be when device documents are loaded and are ready for editing/work.

Instructions 408 may include instructions to adjust electronic device 100 from the device ready state to a low power state if electronic device 100 remains unused after the time duration. As noted above, the time duration may be determined by usage trends (historical usage data) as discussed in FIG. 3. The device ready state may be adjusted to another power state other than the low power state. In one example, the power state adjustment may be based on user selection.

Instructions 410 may include instructions to set electronic device 100 to a low power state to reduce battery power usage if electronic device 100 is in a backpack mode.

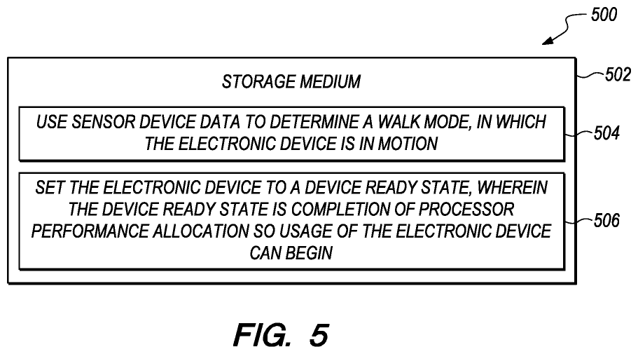

FIG. 5 illustrates an example computer storage medium 500 according to an example of the present disclosure.

Computer readable-storage medium 500 can include non-transitory machine-readable storage medium 502. Non-transitory machine-readable storage medium 502 may be magnetic, optical, electronic or other storage devices that can execute machine-readable storage instructions. Non-transitory machine-readable storage instructions 502 may be EEPROM (electrically-erasable programmable read-only memory), RAM (random access memory) or other such devices.

Alternatively, non-transitory machine-readable storage medium 502 may be remote allowing the system to download instructions. Non-transitory machine-readable storage medium 502 may also be encoded with executable instructions to determine user activity modes and to set device states.

Instructions 504 may include instructions to use sensor device data to determine a walk mode in which electronic device 100 (FIG. 1) is in motion. In one example, electronic device 100 is in motion by virtue of being held by a user that is walking.

Instructions 506 may include instructions to set electronic device 100 to a device ready state. The device ready state may be the completion of processor performance allocation so that usage of electronic device 100 can begin.

While the above is a complete description of exemplary specific examples of the disclosure, additional examples are also possible. Thus, the above description should not be taken as limiting the scope of the disclosure, which is defined by the appended claims along with their full scope of equivalents.

1. An electronic device, comprising:
a battery;
a power adapter;
a sensor device;
a processor;
memory, storing machine-readable instructions to cause the processor to:
determine, using sensor device data, which one of a walk mode and a backpack mode the electronic device is in, wherein the electronic device is in motion during the walk mode, and wherein the electronic device is in motion and is disposed in a bag during the backpack mode; and
set the electronic device to a device ready state if the electronic device is in the walk mode,
set the electronic device to a low power state to reduce battery power usage if the electronic device is in the backpack mode.

2. The electronic device of claim 1 further comprising instructions to cause the processor to:
determine, based on usage trends of the electronic device, a time of next use of the electronic device.

3. The electronic device of claim 2 further comprising instructions to cause the processor to:
adjust the electronic device from the device ready state to a low power state if the electronic device remains unused after the determined time of next use.

4. The electronic device of claim 1 wherein the device ready state is when processor performance allocation is completed, so usage of the electronic device can begin.

5. The electronic device of claim 1 wherein the sensor device is an accelerometer to acquire electronic device acceleration data and wherein the memory comprises a trained data set for acceleration.

6. The electronic device of claim 5 wherein the electronic device acceleration data and the trained data set for acceleration are to determine the electronic device is in the walk mode.

7. The electronic device of claim 5 further comprising
a pressure sensor to acquire electronic device pressure data,
wherein the electronic device pressure data, the electronic device acceleration data and the trained data set for acceleration are to determine the electronic device is in the backpack mode.

8. A non-transitory machine-readable storage medium having stored thereon machine-readable instructions to cause a processor of an electronic device to:
use sensor device data to determine a walk mode, in which the electronic device is in motion; and
set the electronic device to a device ready state, wherein the device ready state is completion of processor performance allocation so usage of the electronic device can begin.

9. The medium of claim 8 further comprising instructions to:
use the sensor device data to determine the electronic device is in a backpack mode, if the electronic device is not in the walk mode; and
set the electronic device to a low power state to reduce battery power usage.

10. The medium of claim 8 further comprising instructions to:
adjust the electronic device from the device ready state to a low power state if the electronic device remains unused after a time duration.

11. The medium of claim 9 wherein the sensor device data includes electronic device acceleration data and electronic device pressure data to determine the electronic device is in the backpack mode.

12. A non-transitory machine-readable storage medium having stored thereon machine-readable instructions to cause a processor of an electronic device to:
use sensor device data to determine one of a walk mode and a backpack mode, wherein the electronic device is in motion during the walk mode, and wherein the electronic device is in motion and is disposed in a bag during the backpack mode;
set the electronic device to a device ready state for a time duration if the electronic device is in the walk mode, wherein the time duration is based on electronic device historical usage data;
adjust the electronic device from the device ready state to a low power state if the electronic device remains unused after the time duration; and
set the electronic device to the low power state to reduce battery power usage if the electronic device is in the backpack mode.

13. The medium of claim 12 wherein the sensor device data includes electronic device acceleration data to determine the electronic device is in the walk mode.

14. The medium of claim 12 wherein the sensor device data includes electronic device acceleration data, the instructions causing the processor to:
use the electronic device acceleration data and an acceleration trained data set to determine the walk mode or the backpack mode.

15. The medium of claim 12 further comprising instructions to:
adjust the electronic device from the device ready state to a low power state if the electronic device remains unused after the time duration.
